(19) United States
(12) Patent Application Publication
(10) Pub. No.: US 2019/0206425 A1
(43) Pub. Date: Jul. 4, 2019

(54) INFORMATION CAPTURING DEVICE AND VOICE CONTROL METHOD

(71) Applicant: GETAC TECHNOLOGY CORPORATION, HSINCHU COUNTY (TW)

(72) Inventor: MIN-TAI CHEN, Taipei City (TW)

(21) Appl. No.: 16/151,223

(22) Filed: Oct. 3, 2018

Related U.S. Application Data
(60) Provisional application No. 62/612,998, filed on Jan. 2, 2018.

(51) Int. Cl. G10L 25/84; G10L 15/22; G10L 25/51; H04N 7/18; H04N 5/232

(52) U.S. Cl. CPC G10L 25/84; G10L 15/22; G10L 2015/223; H04N 7/188; H04N 5/232; G10L 25/51

(57) ABSTRACT

A voice control method for an information capturing device includes: receiving a sound signal, comparing the sound signal with at least a gunshot datum, performing voice recognition on the sound signal so as to obtain an actual voice content, confirming at least a command voice content according to the actual voice content; obtaining, if the actual voice content corresponds to any one the command voice content, an operation command corresponding to the command voice content such that the information capturing device performs an operation in response to and corresponding to the operation command; and outputting, if the sound signal matches any one the gunshot datum, a start recording command such that the information capturing device performs video recording in response to the start recording command.

### CROSS-REFERENCE TO RELATED APPLICATIONS

This application claims priority from U.S. Patent Application Ser. No. 62/612,998, filed on Jan. 2, 2018, the entire disclosure of which is hereby incorporated by reference.

### BACKGROUND OF THE INVENTION

### Field of the Invention

The present disclosure relates to technology of controlling information capturing devices and, more particularly, to an information capturing device and voice control technology related thereto.

### Description of the Prior Art

Police officers on duty have to record sounds and shoot videos in order to collect evidence and preserve the evidence. Hence, police officers on duty wear information capturing devices for capturing medium-related data, including images and sounds, from the surroundings, so as to facilitate policing. The medium-related data recorded by the information capturing devices is descriptive of real-time on-site conditions of an ongoing event with a view to fulfilling burdens of proof and clarifying liabilities later.

Users operate start switches of conventional portable information capturing devices in order to enable the portable information capturing devices to capture data related to the surroundings. However, in an emergency, a typical scenario is as follows: it is too late for the users to start capturing data by hand; or images and/or sounds related to a crucial situation have already vanished by the time the users start capturing data by hand.

### SUMMARY OF THE INVENTION

In an embodiment of the present disclosure, a voice control method for an information capturing device includes the steps of: receiving a sound signal; comparing the sound signal with at least a gunshot datum; performing voice recognition on the sound signal so as to obtain an actual voice content; confirming at least a command voice content according to the actual voice content; obtaining, if the actual voice content corresponds to any one the command voice content, an operation command corresponding to the command voice content such that the information capturing device performs an operation in response to and corresponding to the operation command; and outputting, if the sound signal matches any one the gunshot datum, a start recording command such that the information capturing device performs video recording in response to the start recording command.

In an embodiment of the present disclosure, an information capturing device includes a microphone, a voice recognition unit, a video recording unit and a control unit. The microphone receives a sound signal. The voice recognition unit is coupled to the microphone, confirms the sound signal according to at least a gunshot datum, and performs voice recognition on the sound signal, so as to obtain an actual voice content. The video recording unit performs video recording to therefore capture an ambient datum. The control unit is coupled to the voice recognition unit and the video recording unit to obtain, if the actual voice content corresponds to a command voice content, an operation command corresponding to the command voice content, perform an operation in response to and corresponding to the operation command, output, if the sound signal matches any one gunshot datum, a start recording command, and start the video recording unit in response to the start recording command.

In conclusion, an information capturing device and a voice control method for the same in embodiments of the present disclosure entails starting video recording in response to a gunshot and performing voice recognition on a sound signal to therefore obtain an actual voice content, so as to obtain a corresponding operation command, thereby performing an operation in response to and corresponding to the operation command.

### BRIEF DESCRIPTION OF THE DRAWINGS

FIG. 1 is a block diagram of circuitry of an information capturing device according to an embodiment of the present disclosure;

FIG. 2 is a flowchart of a voice control method for the information capturing device according to an embodiment of the present disclosure;

FIG. 3 is a block diagram of circuitry of the information capturing device according to another embodiment of the present disclosure;

FIG. 4 is a flowchart of the voice control method for the information capturing device according to another embodiment of the present disclosure;

FIG. 5 is a flowchart of the voice control method for the information capturing device according to another embodiment of the present disclosure; and

FIG. 6 is a flowchart of the voice control method for the information capturing device according to yet another embodiment of the present disclosure.

### DETAILED DESCRIPTION OF THE EMBODIMENTS

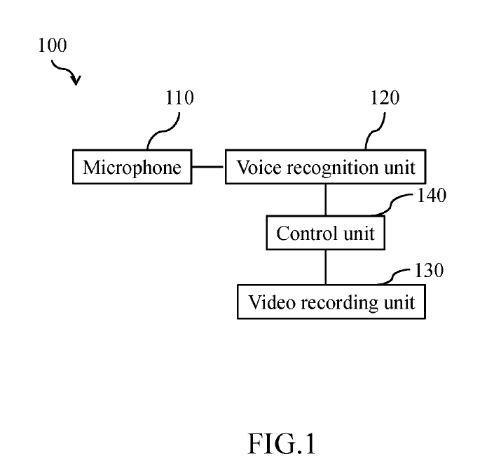

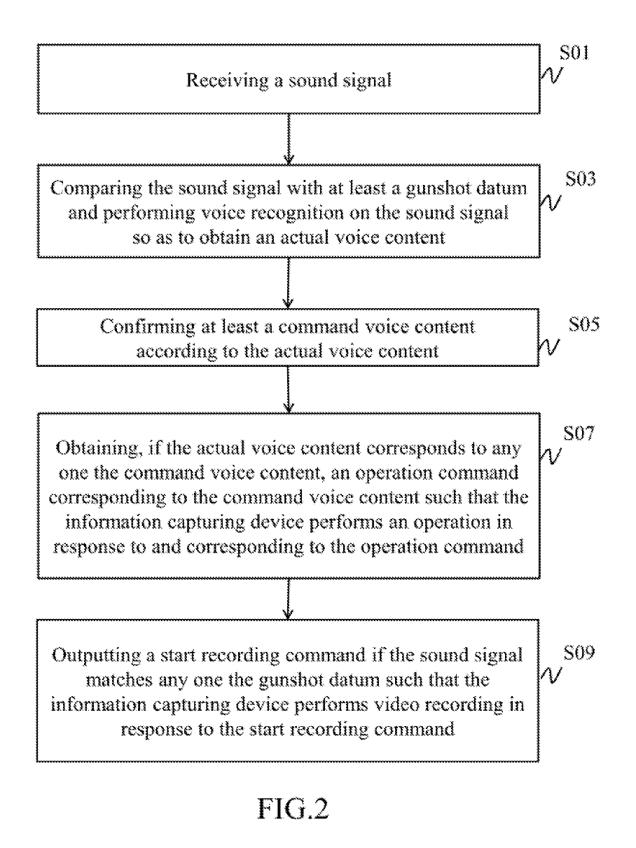

FIG. 1 is a block diagram of circuitry of an information capturing device according to an embodiment of the present disclosure. FIG. 2 is a flowchart of a voice control method for the information capturing device according to an embodiment of the present disclosure. Referring to FIG. 1 and FIG. 2, an information capturing device 100 includes a microphone 110, a voice recognition unit 120, a video recording unit 130 and a control unit 140. The microphone 110 is coupled to the voice recognition unit 120. The voice recognition unit 120 and the video recording unit 130 are coupled to the control unit 140.

The microphone 110 receives an ambient sound. The microphone 110 has a signal processing circuit (not shown). The signal processing circuit turns the ambient sound (sound wave defined in physics) into a sound signal (digital signal) (step S01). The step of receiving an ambient sound involves sensing sounds of the surroundings, and the ambient sound is, for example, a sound generated from a human being, animal or object in the surroundings (such as a horn sound made by a passing vehicle or a shout made by a pedestrian) or a gunshot.

After receiving a sound signal from the microphone 110, the voice recognition unit 120 compares the sound signal with at least a gunshot datum to confirm whether the sound signal matches any one gunshot datum. The voice recognition unit 120 performs voice recognition on the sound signal so as to obtain an actual voice content (step S03).

In an embodiment of step S03, the voice recognition unit 120 analyzes and compares the sound signal with gunshot data of a sound model database, so as to confirm whether the sound signal matches any one gunshot datum. Therefore, the voice recognition unit 120 analyzes the sound signal to therefore capture at least a feature of the sound signal, and then the voice recognition unit 120 compares the at least a feature of the sound signal with signal features of at least one or a plurality of gunshot data of the sound model database, so as to confirm whether the sound signal matches any one gunshot datum.

In an embodiment of step S03, the voice recognition unit 120 analyzes and compares a sound signal with sound signals of the sound model database, so as to confirm whether the sound signal matches any one gunshot datum. Therefore, the voice recognition unit 120 analyzes the sound signal to therefore capture at least a feature of the sound signal, and then the voice recognition unit 120 discerns or compares the at least a feature of the sound signal and voice data of the sound model database to therefore select or determine a text content of the sound signal, so as to obtain an actual voice content which matches the at least a feature of the sound signal.

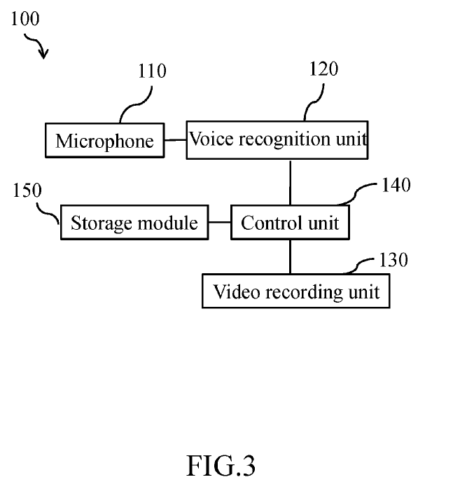

In an exemplary embodiment, the information capturing device 100 further includes a sound model database. The sound model database includes at least one or a plurality of gunshot data and at least one or a plurality of voice data. The gunshot data are signals pertaining to sounds generated as a result of the firings of various types of handguns. Each voice datum is in the form of a glossary, that is, word strings composed of one-word terms, multiple-word terms, and sentences, as well as their pronunciations. In an embodiment, the sound model database is stored in a storage module 150 of the information capturing device 100. Therefore, the information capturing device 100 further includes a storage module 150 (as shown in FIG. 3). The storage module 150 is coupled to the control unit 140.

The control unit 140 receives the actual voice content from the voice recognition unit 120 and confirms at least a command voice content according to the actual voice content (step S05). In an exemplary embodiment, relationship between the actual voice content and the at least a command voice content is recorded in a lookup table (not shown) such that the control unit 140 searches the lookup table for at least one or a plurality of command voice contents and confirms the command voice content(s) corresponding to the actual voice content. In an embodiment aspect, the lookup table is stored in the sound module 150 of the information capturing device 100. The sound module 150 is coupled to the control unit 140. In an exemplary embodiment, an actual voice content corresponding to any one command voice content is identical to the command voice content in whole. For instance, the actual voice content is a “start recording command,” whereas the command voice content is “start recording.” In another exemplary embodiment, an actual voice content corresponding to any one command voice content is identical to the command voice content in part above a specific ratio. For instance, the actual voice content is “start,” whereas the command voice content is “start recording.” In another exemplary embodiment, an actual voice content corresponding to any one command voice content includes a content identical to the command voice content and another content (such as an ambient sound content) different from the command voice content. For instance, an actual voice content is “start recording,” and an ambient sound content which differs from the command voice content, whereas the command voice content is “start recording.”

If the actual voice content corresponds to any one command voice content, that is, the actual voice content corresponds to the command voice content in whole or corresponds to the command voice content and the other non-command voice contents (such as an ambient sound content), the control unit 140 obtains an operation command corresponding to the command voice content according to the command voice content corresponding to the actual voice content, and in consequence the information capturing device 100 performs an operation in response to and corresponding to the operation command (step S07). In an exemplary embodiment of step S07, after finding a corresponding command voice content in the lookup table, the control unit 140 fetches from the lookup table the operation command corresponding to the command voice content found.

If the sound signal matches any one gunshot datum, that is, in step S03, if the voice recognition unit 120 compares the feature of a sound signal with the signal features of at least one or a plurality of gunshot data of the sound model database and then confirms that the sound signal matches any one gunshot datum, the voice recognition unit 120 sends to the control unit 140 the comparison result that the sound signal matches any one gunshot datum, and in consequence the control unit 140 outputs a start recording command, causing the information capturing device 100 to perform video recording in response to the start recording command (step S09). In step S09, the control unit 140 controls, in response to the start recording command, the video recording unit 130 to perform video recording so as to capture an ambient datum, that is, recording images and/or sounds of the surroundings (such as a horn sound made by a passing vehicle or a shout made by a pedestrian), or images and/or sounds of a gunshot. In some embodiments, if the sound signal does not match any one gunshot datum, that is, in the absence of any gunshot, the control unit 140 instructs the information capturing device 100 to perform an operation in response to and corresponding to the operation command (step S07) but not to respond to the start recording command (i.e., not to execute step S09).

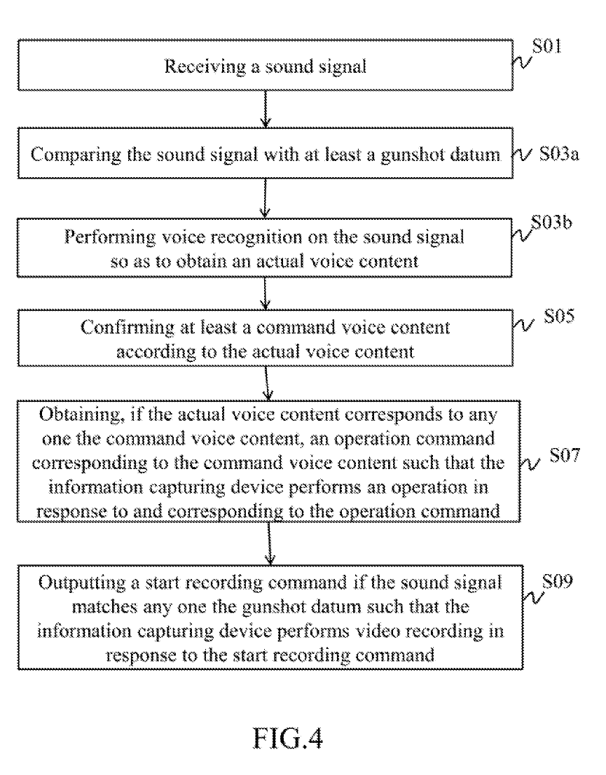

In some embodiments, in an embodiment of step S03, as shown in FIG. 2, the voice recognition unit 120 simultaneously compares a sound signal with at least a gunshot datum and performs voice recognition on the sound signal so as to obtain an actual voice content. In some other embodiments, as shown in FIG. 4, the voice recognition unit 120 compares a sound signal with at least a gunshot datum (step S03a) and then performs voice recognition on the sound signal so as to obtain an actual voice content (step S03b).

Although the aforesaid steps are described sequentially, the sequence is not restrictive of the present disclosure. Persons skilled in the art understand that under reasonable conditions some of the steps may be performed simultaneously or in reverse order.

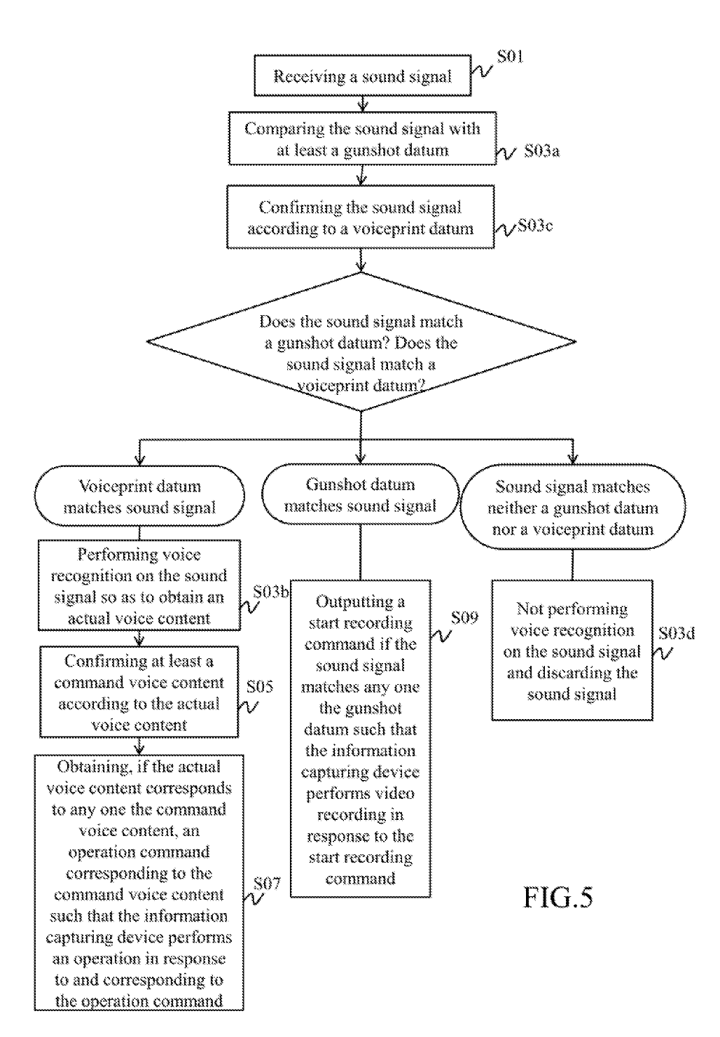

FIG. 5 is a flowchart of the voice control method for the information capturing device according to another embodiment of the present disclosure. As shown in FIG. 5, before executing step S03b, the control unit 140 confirms the sound signal according to a voiceprint datum (step S03c). As shown in the diagram, step S05, step S07, and step S09 are substantially identical to their aforesaid counterparts.

In step S03c, the voice recognition unit 120 analyzes the sound signal and thus creates an input sound spectrum such that the voice recognition unit 120 discerns or compares features of the input sound spectrum and features of a predetermined sound spectrum of a voiceprint datum to therefore perform identity authentication on a user, thereby identifying whether the sound is attributed to the user's voice. In an embodiment aspect, the user records each operation command beforehand with the microphone 110 in order to configure a predetermined sound spectrum correlated to the user and corresponding to each operation command. The voiceprint datum is the predetermined sound spectrum corresponding to each operation command. In an embodiment aspect, the voiceprint datum is a predetermined sound spectrum which corresponds to each operation command and is recorded beforehand by one or more users. In an embodiment aspect, the voiceprint datum is stored in the sound module 150 of the information capturing device 100 (as shown in FIG. 3).

The control unit 140 performs voice recognition on the sound signal so as to obtain an actual voice content, only if the sound signal matches the voiceprint datum, that is, only if the feature of the input sound spectrum matches the feature of the predetermined sound spectrum of the voiceprint datum (step S03b). Afterward, the information capturing device 100 executes step S05 through step S07.

If the sound signal matches the gunshot datum, the voice recognition unit 120 sends to the control unit 140 the comparison result that the sound signal matches any one gunshot datum such that the control unit 140 outputs a start recording command to cause the information capturing device 100 to perform video recording in response to the start recording command (step S09).

If the sound signal matches neither the voiceprint datum nor any one gunshot datum, that is, if the feature of the input sound spectrum does not match the feature of the predetermined sound spectrum of the voiceprint datum and no gunshot occurs, the control unit 140 does not perform voice recognition on the sound signal but discards the sound signal (step S03d).

If the sound signal not only matches the voiceprint datum but also matches any one gunshot datum, the control unit 140 proceeds to execute step S03b, step S05, step S07 through step S09.

In some embodiments, the operation command is “start recording command,” “finish recording command” or “sorting command.” In some other embodiments, the operation command is “command of feeding back the number of hours video-recordable,” “command of saving files and playing a prompt sound by a sound file,” “command of feeding back remaining capacity” or “command of feeding back resolution.” The aforesaid examples of the operation command are illustrative, rather than restrictive, of the present disclosure; hence, persons skilled in the art understand that under reasonable conditions the operation command may be programmed and thus created or altered.

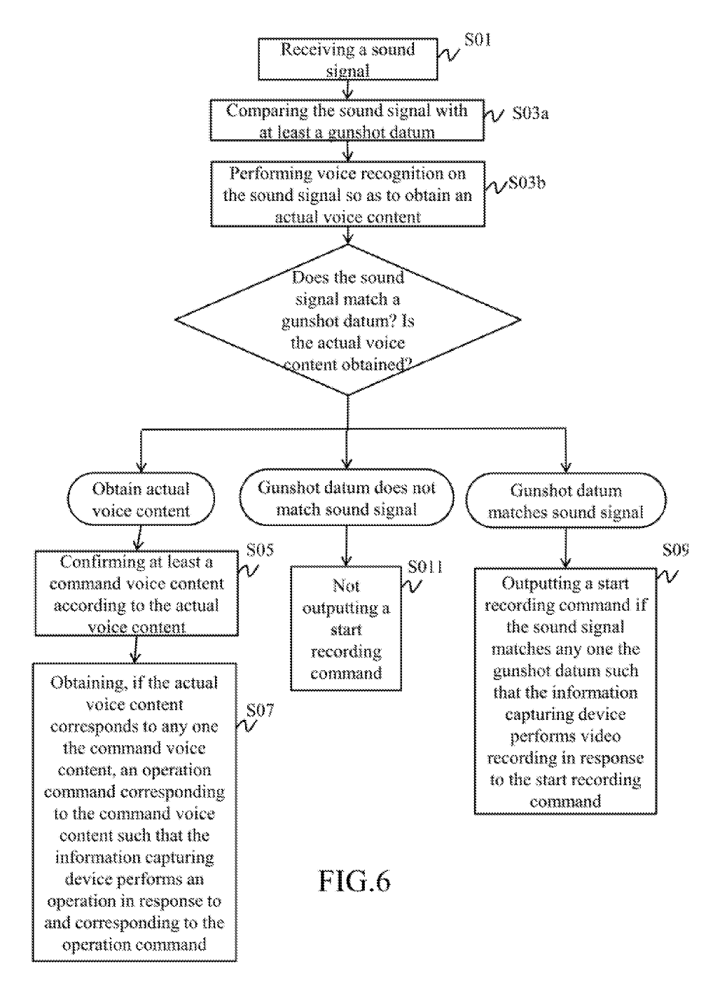

FIG. 6 is a flowchart of the voice control method for the information capturing device according to yet another embodiment of the present disclosure. In an exemplary embodiment, as shown in FIG. 1 and FIG. 6, if the user says “start camera recording” to the microphone 110 and the ambient sound does not include a gunshot, the microphone 110 will receive a sound signal (step S01) and send the sound signal to the voice recognition unit 120. The voice recognition unit 120 compares the feature of a sound signal with signal features of at least one or a plurality of gunshot data of the sound model database, so as to confirm whether the sound signal matches any one gunshot datum (step S03a). The voice recognition unit 120 performs voice recognition on the sound signal so as to obtain an actual voice content of “start camera recording” (step S03b). The control unit 140 sequentially confirms the command voice contents recorded in the lookup table according to the actual voice contents of “start camera recording” obtained according to results of voice recognition (step S05), so as to identify the command voice content corresponding to the actual voice content. After identifying the command voice content, the control unit 140 fetches from the lookup table the operation command of “start recording command” corresponding to the command voice content, and then the control unit 140 controls, in response to the start recording command (i.e., in response to the operation command), the video recording unit 130 to perform video recording so as to capture the ambient datum (i.e., perform an operation corresponding to the operation command) (step S07). Although in step S03a the control unit 140 compares the feature of a sound signal with the signal features of at least one or a plurality of gunshot data of the sound model database and then confirms that the sound signal does not match any one gunshot datum, the control unit 140 still controls, in response to the start recording command (i.e., in response to the operation command), the video recording unit 130 to perform video recording so as to capture the ambient datum (i.e., perform an operation corresponding to the operation command) (step S07). In another exemplary embodiment, if a gunshot occurs and the user says “start camera recording” to the microphone 110, it means that the control unit 140 receives the start recording command corresponding to the actual voice content and the start recording command corresponding to the gunshot. As a result, the control unit 140 responds to the first-received start recording command and then discards the later-received start recording command (i.e., no longer executes the later-received start recording command.)

In an exemplary embodiment illustrated by FIG. 1 and FIG. 6, if the microphone 110 receives an ambient sound which includes a gunshot but not any voice of the user, the microphone 110 receives a sound signal (step S01) and sends the sound signal to the voice recognition unit 120. The voice recognition unit 120 compares the feature of a sound signal with the signal features of at least one or a plurality of gunshot data of the sound model database (step S03a), so as to confirm whether the sound signal matches any one gunshot datum. The voice recognition unit 120 performs voice recognition on the sound signal (step S03b). In step S03a, if the control unit 140 compares the feature of a sound signal with the signal features of at least one or a plurality of gunshot data of the sound model database and confirms that the sound signal matches any one gunshot datum, the control unit 140 outputs a start recording command such that the control unit 140 of the information capturing device 100 controls, in response to the start recording command, the video recording unit 130 to perform video recording so as to capture an ambient datum (step S09).

If the microphone 110 receives an ambient sound once again and the ambient sound includes “end camera recording” said by the user but not a gunshot, the microphone 110 receives a sound signal (step S01) and sends the sound signal to the voice recognition unit 120. The voice recognition unit 120 compares the feature of a sound signal with the signal features of at least one or a plurality of gunshot data of the sound model database (step S03a), so as to confirm whether the sound signal matches any one gunshot datum. The voice recognition unit 120 performs voice recognition on the sound signal (step S03b) so as to obtain an actual voice content of “end camera recording.” The control unit 140 sequentially confirms the command voice contents recorded in the lookup table according to the actual voice contents of “end camera recording” obtained according to results of voice recognition (step S05), so as to identify the command voice content corresponding to the actual voice content. After identifying the command voice content, the control unit 140 fetches from the lookup table the operation command of “finish recording command” corresponding to the command voice content, the control unit 140 controls, in response to the finish recording command (i.e., in response to the operation command), the video recording unit 130 to finish video recording so as to create an ambient datum (i.e., perform an operation corresponding to the operation command) (step S07).

In an exemplary embodiment illustrated by FIG. 1 and FIG. 6, if the microphone 110 receives an ambient sound which includes a gunshot and “event 1” said by the user, the microphone 110 receives a sound signal (step S01) and sends the sound signal to the voice recognition unit 120. The voice recognition unit 120 compares the feature of a sound signal with the signal features of at least one or a plurality of gunshot data of the sound model database, so as to confirm whether the sound signal matches any one gunshot datum (step S03a). The voice recognition unit 120 performs voice recognition on the sound signal, so as to obtain an actual voice content of “event 1” (step S03b). The control unit 140 sequentially confirms the command voice contents recorded in the lookup table according to an actual voice content of “event 1” obtained according to results of voice recognition (step S05), so as to identify the command voice content corresponding to the actual voice content. After identifying the command voice content, the control unit 140 fetches from the lookup table the operation command of “sorting command” corresponding to the command voice content, and then the control unit 140 names the video file “event 1” in response to the operation command of “sorting command” (i.e., in response to the operation command) (step S07). If the sound signal matches any one gunshot datum, the control unit 140 outputs a start recording command such that the control unit 140 of the information capturing device 100 controls, in response to the start recording command, the video recording unit 130 to perform video recording so as to capture an ambient datum (step S09). In yet another exemplary embodiment, the control unit 140 responds to the operation command of “sorting command” before or after the step of starting video recording gunshot or the step of starting video recording voice (the user says “start camera recording” to the microphone 110.)

In some embodiments, the video recording unit 130 is implemented as an image pickup lens and an image processing unit. In an exemplary embodiment, the image processing unit is an image signal processor (ISP). In another exemplary embodiment, the image processing unit and the control module 130 is implemented by the same chip, but the present disclosure is not limited thereto.

In some embodiments, the control unit 140 is implemented as one or more processing components. The processing components are each a microprocessor, microcontroller, digital signal processor, central processing unit (CPU), programmable logic controller, state machine, or any analog and/or digital device based on the operation command and the operation signal, but the present disclosure is not limited thereto.

In some embodiments, the sound module 150 is implemented as one or more sound components. The sound components are each, for example, a memory or a register, but the present disclosure is not limited thereto.

In some embodiments, the information capturing device 100 is a portable image pickup device, such as a wearable camera, a portable evidence-collecting camcorder, a mini camera, or a hidden voice recorder mounted on a hat or clothes. In some embodiments, the information capturing device 100 is a stationary image pickup device, such as a dashboard camera mounted on a vehicle.

In conclusion, an information capturing device and a voice control method for the same in embodiments of the present disclosure entails starting video recording in response to a gunshot and performing voice recognition on a sound signal to therefore obtain an actual voice content, so as to obtain a corresponding operation command, thereby performing an operation in response to and corresponding to the operation command.

Although the present disclosure is disclosed above by preferred embodiments, the preferred embodiments are not restrictive of the present disclosure. Slight changes and modifications made by persons skilled in the art to the preferred embodiments without departing from the spirit of the present disclosure must be deemed falling within the scope of the present disclosure. Accordingly, the legal protection for the present disclosure should be defined by the appended claims.

What is claimed is:

1. A voice control method for an information capturing device, comprising the steps of:
receiving a sound signal;
comparing the sound signal with at least a gunshot datum;
performing voice recognition on the sound signal so as to obtain an actual voice content;
confirming at least a command voice content according to the actual voice content;
obtaining, if the actual voice content corresponds to any one the command voice content, an operation command corresponding to the command voice content such that the information capturing device performs an operation in response to and corresponding to the operation command; and
outputting, if the sound signal matches any one the gunshot datum, a start recording command such that the information capturing device performs video recording in response to the start recording command.

2. The method of claim 1, further comprising the steps of:
confirming the sound signal according to a voiceprint datum;
performing the voice recognition on the sound signal only if the sound signal matches the voiceprint datum; and
not performing the voice recognition on the sound signal but discarding the sound signal if the sound signal matches neither the voiceprint datum nor any one said gunshot datum.

3. The method of claim 1, wherein the operation command is the start recording command.

4. The method of claim 1, wherein the operation command is a finish recording command.

5. The method of claim 1, wherein the operation command is a sorting command.

6. An information capturing device, comprising:
a microphone for receiving a sound signal;
a voice recognition unit coupled to the microphone to confirm the sound signal according to at least a gunshot datum and perform voice recognition on the sound signal so as to obtain an actual voice content;
a video recording unit for performing video recording so as to capture an ambient datum; and
a control unit coupled to the voice recognition unit and the video recording unit and adapted to obtain, if the actual voice content corresponds to a command voice content, an operation command corresponding to the command voice content, perform an operation in response to and corresponding to the operation command, output, if the sound signal matches any one said gunshot datum, a start recording command, and start the video recording unit in response to the start recording command.

7. The information capturing device of claim 6, wherein the voice recognition unit confirms the sound signal according to a voiceprint datum and performs the voice recognition on the sound signal only if the sound signal matches the voiceprint datum, but does not perform the voice recognition on the sound signal if the sound signal does not match the voiceprint datum.

8. The information capturing device of claim 7, wherein the voice recognition unit discards the sound signal if the sound signal matches neither the voiceprint datum nor any one said gunshot datum.

9. The information capturing device of claim 6, wherein the operation command is the start recording command.

10. The information capturing device of claim 6, wherein the operation command is a finish recording command.

11. The information capturing device of claim 6, wherein the operation command is a sorting command.
